(19) United States
(12) Patent Application Publication
(10) Pub. No.: US 2026/0324678 A1
(43) Pub. Date: Oct. 22, 2026

(54) TEXTURED PLANT PROTEIN PRODUCT WITH HIGH FIBRE CONTENT

(71) Applicant: VALIO OY, HELSINKI (FI)

(72) Inventor: Elli LAUKKALA, Raisio (FI)

(21) Appl. No.: 19/109,688

(22) PCT Filed: Oct. 2, 2023
(86) PCT No.: PCT/FI2023/050559

§ 371 Date: Mar. 7, 2025

(30) Foreign Application Priority Data
Sep. 30, 2022 (FI) 20227128

(51) Int. Cl. A23J 3/14; A23J 3/22; A23J 3/26

(52) U.S. Cl. CPC A23J 3/14; A23J 3/227; A23J 3/26

(57) ABSTRACT

The present invention relates to a textured plant protein product rich in dietary fibres, to a method for the preparation thereof and to food products including the textured plant protein product.

### FIELD OF THE INVENTION

The present invention relates to food products and especially to a textured plant protein product and to a method of preparing the same.

### BACKGROUND

Global consumption of meat has more than doubled since 1990, and most people in high-income countries eat meat in amounts that exceed nutritional needs. This is problematic given that the overconsumption of meat is associated with serious negative health and environmental impacts.

Indeed, there is growing consensus that reducing excess meat consumption will be necessary not only to meet climate change targets and reduce the release of greenhouse gases such as methane, CO₂, and nitrous oxide, but also to promote people's health. However, despite increased awareness of sustainable and healthy food consumption, broader consumer acceptance for plant-based meat alternatives is still needed to achieve reduced meat consumption.

The main barriers for the consumption of meat alternatives among average meat-eating consumers have been identified to include lower sensory appeal as well as unfamiliarity and concerns relating to convenience. Indeed, consumer studies have demonstrated that meat alternatives have the best chance of successfully replacing meat when they closely resemble processed meat products in taste and texture. Therefore, there is an identified need for delicious plant-based meat alternatives that can easily be swapped to in existing family recipes to replace meat, such as minced meat.

### BRIEF DESCRIPTION OF THE INVENTION

The invention relates to a textured plant protein product according to independent claim 1, to a method according to independent claim 14 for preparing said textured plant protein product, to a textured plant protein product obtainable by said process, as well as to a food product comprising said textured plant protein product.

Some embodiments of the invention are set forth in the dependent claims. Further embodiments become apparent from the detailed description and the examples.

### DETAILED DESCRIPTION OF THE INVENTION

It has now been unexpectedly realized that saccharide-containing syrups do not only provide flavour and colour into edible products obtainable by protein texturization extrusion, but also contribute to the appearance, texture, mouthfeel and bite resistance of the product. This applies in particular to textured plant protein products rich in dietary fibres, especially cereal fibres.

Before the invention is further described, it is to be understood that this disclosure is not strictly limited to the particular embodiments described herein, as such can of course vary. It is also to be understood that the terminology used herein is for the purpose of describing particular embodiments only, and is not intended to be limiting, since the scope of the present invention will be limited only by the appended claims.

It is also to be noted that, unless defined otherwise, all technical and scientific terms used herein have the same meaning as commonly understood by one of ordinary skill in the art to which this invention belongs.

It is further to be noted that certain features of the disclosure, which are, for clarity, described in the context of separate embodiments, can also be provided in combination in a single embodiment. Conversely, various features of the disclosure, which are, for brevity, described in the context of a single embodiment, can also be provided separately or in any suitable sub-combination. Moreover, all combinations of the embodiments are specifically embraced by the present disclosure and are disclosed herein just as if each and every combination was individually and explicitly disclosed. In addition, all sub-combinations are also specifically embraced by the present disclosure and are disclosed herein just as if each and every such sub-combination was individually and explicitly disclosed herein.

All ranges and parameters, including but not limited to percentages and ratios disclosed herein, are understood to encompass any and all sub-ranges subsumed therein, and every number between the endpoints. For example, a stated range of “1 to 10” should be considered to include any and all sub-ranges beginning with a minimum value of 1 or more and ending with a maximum value of 10 or less, including all integers, whole or fractions, contained within the range. Thus, the stated range of “1 to 10” should be construed as supporting, for example, a range of from 1 to 8, from 3 to 6.6, from 1 to 9, from 3.6 to 5, from 3.5 to 9.9, and so forth.

As used herein, the term “about” refers to a range of values ±10% of a specified value. For example, the phrase “about 80 wt %” includes ±10% of 80 wt %, or from 72 wt % to 88 wt %.

As used herein and in the appended claims, the singular forms “a”, “an”, and “the” mean one or more. Thus, a singular noun, unless otherwise specified, carries also the meaning of the corresponding plural noun, and vice versa. As such, the terms “a”, “an”, “one or more” and “at least one” can be used interchangeably.

As used herein, the term “and/or” in a phrase such as “X and/or Y” shall be understood to mean either “X and Y” or “X or Y” and shall be taken to provide explicit support for both meanings or for either meaning.

As used herein, the terms “comprising”, “including”, “containing” and “having” are interchangeable.

Embodiments and details disclosed in the context of discussing the product of the invention apply to the method of preparing the product, and vice versa, even if not repeated.

As used herein, the term “textured plant protein product” refers broadly to a food product that has been transformed from an edible flour-type protein material into one which has a meat-like texture with protein fibres that are substantially aligned in a manner similar to protein in animal meat.

The textured plant protein product of the invention has a high total plant protein content, preferably ranging from about 30% to about 80% on dry weight basis calculated from the total dry weight of the product, depending on the amount of plant protein component(s) used, as well as on the type and plant source (i.e. origin) of said component(s). Accordingly, the total plant protein content of the product may vary from about 30, 35, 40, 45, 50, 55, 60, 65, 70, 75 wt % up to about 35, 40, 45, 50, 55, 60, 65, 70, 75, 80 wt % on dry matter basis.

In some embodiments, the product comprises a plant protein component in an amount from about 40 to about 75% by dry weight. More specifically, the product may thus comprise, for example, from about 40%, 45%, 50%, 55%, 60%, 65% or 70% up to about 45%, 50%, 55%, 60%, 65%, 70% or 75% of the plant protein component on dry weight basis.

The plant protein component may comprise or consist of a protein concentrate, a protein isolate or any mixture thereof. Optionally, the plant protein component may further comprise a plant flour. The total protein content of the plant protein component may vary depending on the type and source of the protein component(s) employed. For example, the plant protein component may comprise or consist of a mixture of a protein concentrate and a protein isolate derived from the same or different plant sources. However, in order to provide high enough a protein content into the textured plant protein product, the plant protein component should contain protein in a total amount from about 60 to about 99 wt % on dry matter basis. In some other embodiments, the plant protein component may contain protein in a total amount from about 67 wt % to about 84 wt % or from about 73 wt % to about 76 wt % on dry matter basis.

In accordance with the above, the plant protein component may consist of one or more (such as two, three or four) plant protein components. The type of the protein component (that is e.g. a protein concentrate or a protein isolate) may be selected independently from the source of the protein component (i.e. the plant species).

As used herein, the term “plant flour” refers broadly to a powder-type material obtained by milling or grinding of a plant material. The protein content of the plant flour depends on the plant material used, usually ranging from about 8 to about 40 wt % on dry matter basis. For example, a typical legume flour has a protein content from about 20 to about 40 wt %, while a typical oat endosperm flour has a protein content from about 8 to about 13 wt % and a typical wholegrain oat flour has a protein content from about 13 to about 18 wt % or higher on dry matter basis.

As used herein, the term “protein concentrate” refers to powdered protein material obtained from a plant source by at least partial removal of soluble carbohydrate and other constituents thereby increasing the relative protein content in the powder. Typically, this can be achieved by air classification. Protein concentrates commonly contain from about 50 wt % to about 80 wt % protein, most commonly from about 60 wt % to about 70 wt % protein on dry matter basis. In other words, the protein content of a typical protein concentrate may vary, for example, from about 50, 55, 60, 65, 70 or 75 wt % up to about 55, 60, 65, 70, 75 or 80 wt % on dry matter basis.

As used herein, the term “protein isolate” refers to powdered protein material that has undergone processing well known in the art to reach a protein content of at least 80 wt %, most commonly between about 80 wt % and about 99 wt % on dry matter basis. In other words, the protein content of a typical protein isolate may vary, for example, from about 80, 82, 84, 86, 88, 90, 92, 94, 96 or 98 wt % up to about 82, 84, 86, 88, 90, 92, 94, 96, 98 or 99 wt % on dry matter basis.

Suitable sources for the plant protein component include nuts, cereals, seeds, tubers and/or legumes. If the product comprises more than one plant protein component, they may be derived from species belonging to the same or different plant categories mentioned above. That is to say that if the product comprises, for example, two plant protein components, one of them may be derived from legumes and the other one from nuts, cereals, seeds or tubers, or both of them may be derived from legumes, for instance. In some embodiments, the latter option is preferred.

Non-limiting examples of suitable legumes include fava beans, chickpeas, peas (Pisum spp.) such as garden pea (Pisum sativum var. sativum), protein pea (Pisum sativum var. arvense) and field peas (Pisum sativum L.) including e.g. green peas and yellow peas, lentils, peanuts, trefoil, pinto beans, haricot beans, mung beans, navy beans, red beans, black beans, dark and light red kidney beans, green baby lima beans, pink beans, myasi beans, black eyed beans, cranberry beans, white beans, rice beans, butter beans, soybeans and the like. However, in some embodiments, none of the one or more plant protein components, nor any other component of the product, is derived from soybeans. Such products may be denoted as soy-free.

Non-limiting examples of nut protein sources include pecans, hazelnuts, walnuts, Brazil nuts, cashews and almonds, whereas cereal proteins may be derived from sources such as rice, oats, amaranth, barley, buckwheat, fonio, millet, rye, wheat, sorghum, triticale, or quinoa. However, in some embodiments, none of the one or more plant protein components, nor any other component of the product, is derived from wheat and/or barley, i.e. the product is wheat-free and/or barley-free. In some embodiments, the product is gluten-free, especially wheat gluten-free and/or barley gluten-free. In some embodiments, the one or more protein components are not derived from oats. This does not exclude the possibility of the product comprising some oat protein delivered into the product by a cereal fibre component discussed in more detail below.

Non-limiting examples of seed protein sources include cottonseeds, flaxseeds, rapeseeds and sunflower seeds, whereas tuber protein may be derived, for example, from potatoes. However, in some embodiments, the product does not contain protein components derived from rapeseeds and/or potatoes.

In some embodiments, the plant protein component comprises or consists of one or more legume-derived protein components, such as pea protein components and/or fava bean protein components. In some embodiments, the amount of pea protein components may vary from about 50 wt % to about 100 wt % calculated from the total weight of plant protein components in the textured plant protein product of the invention. In some embodiments, each of the one or more plant protein components are derived from peas (Pisum spp.). In some embodiments, the plant protein component consists of a pea isolate, while in some other embodiments, the plant protein component may consist of a pea protein isolate and a pea protein concentrate. In some further embodiments, the plant protein component comprises or consist of two or more legume-derived protein components derived from different legumes. Such a plant protein component may comprise or consist of a pea protein component and a protein component derived from a legume species other than pea, such as fava bean. In some embodiments, the plant protein component may comprise or consist of a pea protein isolate and a fava bean concentrate. In some further embodiments, the ratio (wt/wt) of the pea protein component, preferably but not necessarily in the form of a pea protein isolate, to the fava bean component, preferably but not necessarily in the form of a fava bean protein concentrate, may vary from about 1.0 to about 4.0. In some preferred embodiments, the ratio is from about 1.0 to about 3.0 or from about 1.0 to about 2.5, including specific weight ratios of about 1.3 and about 2.1.

The textured plant protein product of the invention is rich in dietary fibres, especially cereal fibres. To be more precise, the total dietary fibre content of the textured plant protein product of the invention varies usually within the range of 9-25% by dry weight. In other words, the total dietary content of the product may vary, for example, from 9, 10, 11, 12, 13, 14, 15, 16, 17, 18, 19, 20, 21, 22, 23 or 24% by dry weight up to 10, 11, 12, 13, 14, 15, 16, 17, 18, 19, 20, 21, 22, 23, 14 or 25% by dry weight.

Accordingly, in some embodiments, the present product comprises a cereal fibre component in an amount ranging from about 20 wt % to about 55 wt % on dry basis, in addition to the one or more plant protein components.

In some embodiments, the cereal fibre component is or comprises a cereal bran component derived from one or more cereal sources and/or comprising one or more different cereal bran components derived from a single cereal source.

As used herein, the term “cereal bran” refers to a component mainly comprising the hard outer layers, namely aleurone and pericarp, present in cereal grains, including oats, barley, rye, wheat, millet, rice and corn. The bran is often produced as a by-product of milling in the production of refined grains. Particle size distribution of the bran fraction may vary from coarse to fine. The bran fraction may also be provided as a bran concentrate prepared by removing non-fibre components using means and methods known in the art, including for example air classification.

The bran is particularly rich in dietary fibres, i.e. polysaccharides that cannot be broken down by human digestive enzymes. Beta-glucan is a type of soluble dietary fibre with many health benefits. The dietary fibre content, i.e. the total content of both soluble and non-soluble dietary fibres, as well as the beta-glucan content of the bran depends on the cereal in question. For example, oat bran has a beta-glucan content of usually about 2-8.5% by dry weight and a dietary fibre content of usually about 15-21% by dry weight, largely depending on the cultivar. On the other hand, bran concentrates are enriched in dietary fibres, or especially in soluble dietary fibres such as beta-glucan. In bran concentrates, the proportion of soluble fibres, such as beta-glucan, accounts for, for example, 40-60 wt % of their total dietary fibre content. Accordingly, oat bran concentrates usually contain at least from about 22 to about 41% by dry weight of dietary fibres and/or at least from about 12 wt % to about 22 wt % of beta-glucan. In some embodiments, beta-glucan content can be as high as up to 35 wt % of the concentrate, hence ranging from about 12 wt % to about 35 wt %.

In some embodiments, the textured plant protein product of the invention contains 3-9% by dry weight of beta-glucan. In other words, the beta-glucan content of the product may vary from 3, 4, 5, 6, 7 or 8% by dry weight up to 4, 5, 6, 7, 8 or 9% by dry weight.

In some preferred embodiments, the cereal fibre component used in the textured plant protein product of the invention is a cereal bran component, preferably oat bran, more preferably gluten-free oat bran. Even more preferably, the cereal fibre component is an oat bran concentrate, especially a gluten-free oat bran concentrate. Oat is naturally gluten-free but harvested oats are often contaminated with gluten-containing other cereals such as wheat, rye or barley. The oat bran or the oat bran concentrate is gluten-free, if the oat material used is gluten-free and is not contaminated with other cereals during processing.

Notably, the cereal fibre component is distinct from any plant protein component employed in the present invention to provide proteins into the textured plant protein product, although they, too, may contribute to the total dietary fibre content of the product. Moreover, it is to be understood that any reference to dietary fibres does not refer to the substantially aligned protein fibres in the textured plant protein product of the invention, and vice versa.

The present textured plant protein product also comprises plant-derived syrup, i.e. a viscous liquid mainly composed of saccharides selected from monosaccharides, disaccharides and/or oligosaccharides, optionally containing additional components such as flavours, colours and/or minerals. Preferred syrups include, but are not limited to, syrups comprising a component selected from molasses, such as cane molasses, sugar beet molasses and fruit molasses; corn syrup; brown rice syrup; glucose syrup; inverted sugar syrup; palm syrup; malt extract such as barley malt extract and oat malt extract; and the like. In some embodiments, the syrup is molasses, such as cane molasses, sugar beet molasses or fruit molasses; corn syrup; brown rice syrup; glucose syrup; inverted sugar syrup; palm syrup; or malt extract such as barley malt extract or oat malt extract; or the like. In some preferred embodiments, the syrup comprises or consists of molasses, such as cane molasses, sugar beet molasses or fruit molasses; malt extract such as barley malt extract or oat malt extract; or the like. Edible syrups are generally available, or may be produced by means and methods well known in the art.

The textured plant protein product of the invention comprises syrup in an amount up to about 5 wt %, preferably in an amount from about 1 wt % to about 4 wt % on dry basis, more preferably from about 2 wt % to about 3.5 wt % on dry basis. Notably, the syrup is present during the preparation of the product by protein texturization extrusion, thereby contributing to the texture of the product and, without limitation to any theory, thereby also being integrated into the substantially aligned protein fibres formed. This is to differ from instances, wherein syrup is used only for seasoning a product already prepared by protein texturization extrusion.

Earlier, syrups have been used in some textured plant protein products to achieve improved colour and better taste. Also herein, the syrup contributes to the appealing look and taste of the texture plant protein product, especially by reducing bitter aftertaste. Additionally and unexpectedly, the syrup also improves the texture of the product. For example, the cross-sectional area of the extrudate is more uniform as well as wider and rounder in shape in the presence of the syrup than in the absence of it. This feature is desired, for example, because it improves resemblance to natural meat products, especially minced meat. Overall, the syrup has a surprisingly great impact on the organoleptic properties of the product. Importantly, the presence of the syrup contributes to the water absorption properties of the product such that it absorbs water well but does not become too soft or loose in its texture over time. Consequently, the product has very good bite resistance even after soaking in water.

In some embodiments, the textured plant protein product of the invention is seasoned, i.e. comprises one or more flavouring agents such as spices, herbs and/or flavouring extracts. Non-limiting examples of flavouring agents include salt, monosodium glutamate, black pepper, onion powder, garlic powder, paprika, tomato powder, and dried herbs such as parsley, oregano, thyme, rosemary and sage. The flavouring agents, if present, may be comprised in the textured plant protein product in a total amount of up to about 10 wt % on dry basis, preferably about 0.5-10 wt %, more preferably about 3-8 wt %, even more preferably about 4-6 wt %, and still more preferably about 5 wt % on dry basis.

The textured protein product of the invention may be formulated into a desired shape by using an appropriate die assembly in the extrusion process. Such shapes include, for example, mince, granules, flakes, files, chunks, and cube-shaped pieces. Likewise, the selected shape can be provided in any desired size. In some non-limiting embodiments, the product is provided as a mice or small granules, preferably as a mince or granules whose particle size distribution is within the range of 1-20 mm, preferably within the range of 1-15 mm, more preferably within the range of 2-10 mm, even more preferably within the range of 3-8 mm.

In some embodiments, the present textured protein product is provided as a dry product, i.e. as a product having a moisture content of up to about 12 wt %, preferably up to about 10 wt % to extend the shelf-life of the product and avoid microbiological spoilage. In some embodiments, the moisture content of the dry product is preferably between about 6 wt % and about 10 wt %, more preferably about 8 wt %. To achieve such a low moisture content, the textured plant protein product is usually subjected to a drying step after the extrusion process.

Regardless of whether a drying step is included or not, the textured protein product directly obtainable by the extrusion process may, in the context of the present invention, be denoted as a first textured plant protein product.

When provided as a dry product, the first textured plant protein product is usually to be rehydrated prior to consumption or use in cooking. Typically, the product is to be used as a meat substitute, especially as a minced meat substitute, or as a protein source in vegetarian or vegan food products, or as a meat extender, especially as a minced meat extender, in meat products. Typical food products for such uses include, without limitation, meat balls, burgers, sausages and meat loafs, as well as products that imitate meat balls, burgers, sausages and meat loafs. Notably, although the first textured plant protein product may be used in food products that contain animal-derived components such as meat, the first textured plant protein product in itself is devoid of any animal-derived material, i.e. is fully plant-based. The product of the invention provides not only protein but also meat-like texture into the food products. However, the textured plant protein product may also be used as a protein component in food products that do not intend to imitate meat, such as in granolas, cereal bars, biscuits and the like.

When provided as a dry product, the first textured protein product has typically a bulk density within the range of 100-500 g/l. In some embodiments, the bulk density is 100-300 g/l, such as about 150-200 g/l.

In some embodiments, the first textured protein product is processed further into a second textured plant protein product and provided as a moist product, e.g. as a ready-to-use product, such as a substitute for cooked minced meat. Such a moist product may be obtained, for example, by adding aqueous liquid to the first textured plant protein product such that the moisture content of the second textured plant protein product so obtained is about 60-87% by weight of the product. In some embodiments, about 25-40 wt % of the first textured plant protein product provided as a dry product having a moisture content of 12 wt % or less is mixed with 60-75 wt % of an aqueous liquid to achieve the second textured plant protein product. In some other embodiments, the first textured plant protein product is processed further without an intervening drying step to achieve the second textured plant protein product. In some embodiments, the aqueous liquid is water. In some other embodiments, the aqueous liquid may comprise water and edible fat, preferably vegetable oil, such as rapeseed oil, canola oil and/or sunflower oil, the amount of fat being usually about 6-10 wt %, preferably about 8 wt % of the total weight of the aqueous liquid. In such embodiments, the aqueous liquid may further comprise one or more emulsifiers, such as lecithin, more specifically sunflower lecithin. In some further embodiments, the moist product does not contain any added emulsifier.

In some further embodiments, the one or more flavouring agents described above may be provided into the second product in the aqueous liquid. Accordingly, in some embodiments the aqueous liquid used for the hydration comprises up to about 16 wt %, usually about 0.75-16 wt %, preferably 6-13 wt %, more preferably about 7-8 wt % of one or more flavouring agents in total, in order to deliver up to 10 wt % of flavouring agents into the second textured plant protein product on dry matter basis. Likewise, in order to deliver 5 wt % of flavouring agents into the second product on dry matter basis, the aqueous liquid contains in some embodiments up to about 8 wt %, for example about 3-7 wt % or about 4-6 wt % of flavouring agents in total, depending on the exact amount of the aqueous liquid to be used for hydrating the first textured plant protein product.

In some embodiments, the aqueous liquid, preferably water, and the one or more flavouring agents may be added into the second textured plant protein product to be hydrated separately, i.e. without being premixed. Typically, the one or more flavouring agents are used in an amount of up to 10% or up to 5% by dry weight of the second textured plant protein product. Also the first textured plant protein product may be seasoned with the one or more flavouring agents.

To avoid spoilage, for example due to oxidation and/or microbiological contamination, the textured protein product of the invention, especially when provided as a moist second textured plant protein product, may be packed into an airtight enclosure preferably prepared from plastic, bioplastic, glass or metal. Non-limiting examples of airtight enclosures include hot-sealed plastic or bioplastic bags, glass jars and tin cans. In some embodiments, plastic vacuum packs are preferred.

The first and the second textured protein products of the invention are obtainable by low-moisture protein texturization extrusion, which process is one aspect of the present invention. Basically, there are two different types of extrusion processes for protein texturization in terms of usage of water. Low-moisture extrusion (also called dry extrusion) is an extrusion method wherein premixed dry ingredients are processed in the presence of limited amount of liquid water, usually below 40 wt %. The resulting extrudates are generally dry and crunchy with a long storage-life. High-moisture extrusion (also called wet extrusion) differs from the low-moisture extrusion in the amount of water introduced in the extrusion process, ranging typically from 40-70 wt % in the mixture to be extruded. The resulting products are moist and truly meat-like products with authentic texture and organoleptic properties. The field of the present invention is that of the low-moisture protein texturization extrusion.

In the low-moisture extrusion process, the raw materials, i.e. one or more plant protein components, a cereal fibre component, a syrup component and water, are fed into a closed extruder barrel system. The dry ingredients may be fed into the extruder, preferably through a preconditioner, separately or as a ready premixture. It is also possible to add water and mix it with the dry ingredients outside the extruder, although mixing water into the dry ingredients within the extruder is preferred. In some further embodiments, it is possible to add water to the dry ingredients or a premixture thereof in the preconditioner in the form of liquid, steam or both. More water may be introduced into the process by adding it also into the extruder, usually into the first barrel located after the preconditioner.

In some embodiments, the syrup component is fed into the extruder separately from the dry ingredients, usually into the first barrel located after the preconditioner. Sometimes it may be beneficial to introduce the syrup component as a mixture with water.

The extruder barrel system contains one or more, preferably two, screws that mix and knead the raw materials into a hydrated dough and push the dough composition through successive zones of the barrel system. As the dough composition moves forward in the barrel system, increased heat and pressure convert the dough composition into a melted plasticized mass, while directional shear force causes alignment of the high molecular components in the mass, leading to the formation of substantially aligned protein fibres. The mass is then pushed through a die assembly whose configuration depends on the desired shape of the extrudate. Also the die assembly may contribute to the formation of the fibrous, meat-like texture by providing laminar flow and cooling to the resulting mixture, as is known to those skilled in the art. The die assembly may also be equipped with a cutter, for example a blade chopper, to cut the extrudate into any desired size. After cutting, the extrudate (a first textured plant protein product) is usually dried. However, the cut extrudate may also be subjected to further processing such as seasoning, sterilizing and/or packing without the drying step to obtain a second textured plant protein product.

The extruder may be any suitable extruder, such as a single screw extruder or a twin screw extruder, a twin screw extruder being preferred. Preferably, the extruder screws comprise various parts that have differing screw structure, to allow the hydrated mixture to be effectively formed into a dough. The parts may comprise parts that only convey the material forward (conveying parts), part that mix (mixing parts), other that knead (kneading parts), some may even force the mixture to go backwards (left-handed parts, which create pressure by forcing the material to go backwards). Moreover, the temperature within the various parts of the extruder may vary. A typical length of the extruder may be from 1.5 to 3 meters, such as about 2 meters. The rotation speed of the screw(s) may also vary on the length of the extruder. Typically, also the pressure inside the extruder is higher than the normal atmospheric pressure. It may be achieved either by separate input (increasing pressure) or it may be created by the functioning of the extruder and kneading of the hydrated mixture. Likewise, the temperature may be achieved by heating the extruder or it may be caused by the functioning of the extruder itself. Moreover, the mechanically induced movement of the extruded product also creates heat. Preferably, the temperature in the last barrel is below 170 °C, more preferably below 165 °C. Thus, the temperature may be, for example, from 130, 135, 140, 145, 150, 155, 160 or 165 °C up to 135, 140, 145, 150, 155, 160, 165 or 170 °C.

At the end of the extruder, the dough composition is allowed to exit the extruder via a die assembly to form the extruded product, denoted above as the first textured plant protein product. The die assembly may have any suitable form and length.

After extrusion, the extrudate may be cut into any desired size, using a knife arrangement, cutter or the like. In some embodiments, the extrudate is cut to a particle size of 1-15 mm on average. Thus, the particle size of the first textured plant protein product may vary, for example, from 1, 2, 3, 4, 5, 6, 7, 8, 9, 10, 11, 12, 13 or 14 mm up to 2, 3, 4, 5, 6, 7, 8, 9, 10, 11, 12, 13, 14 or 15 mm on average. A preferred average particle size is 2-10 mm. These exemplary size ranges apply especially to embodiments, where the first product is in the form of small granules or mince, i.e. as a product that is eventually to be processed further into a second product, such as a plant-based alternative to minced meat.

After cutting, the first textured plant protein product is in some embodiments dried using any appropriate dryer, such as a fluid belt dryer, to reduce the moisture content of the product to less than 12% by weight, preferably to a moisture content between about 8% and about 10% by weight. In some embodiments, the drying step also cools the first product, preferably to ambient temperature. Thereafter, the first product may be packed or subjected to further processing to achieve a second textured plant protein product of the invention. However, in some embodiments, the first product may be subjected to further processing directly after cutting, i.e. without drying.

In accordance with what is disclosed above, the method of manufacturing the present textured protein product may, at least in some embodiments, be expressed as a method that starts with providing dry ingredients comprising 40-75% of one or more plant protein components and 20-55% of a cereal bran component by dry weight of the product into an extruder, preferably into a preconditioner. The dry ingredients are fed into a preconditioner along with water, and mixed. The mixture is then passed into the extruder along with some more water to provide a hydrated ingredient mixture, the total amount of water used in the process being up to 40 wt % of the total amount of the ingredient mixture and water. Up to 5 wt % of syrup, such as molasses, is preferably fed into the extruder separately from the dry ingredients. Next, the hydrated ingredient mixture is kneaded at a temperature of 130-170 °C in the extruder, to form a dough composition. The dough composition is then allowed to exit the extruder via a die assembly to form a first textured plant protein product with substantially aligned protein fibres. Preferably, the first product is then cut to have any desired size, such as to an average particle size of 1-15 mm. In some embodiments, the first product is then dried to a moisture content below 12 wt %, preferably between about 8% and about 10%. In some other embodiments, the first product is not dried but used for further processing as such to achieve a second textured plant protein product of the invention.

Processing of the first and the second extruded products may include packing of the products as already discussed above when describing features of the products of the invention. Accordingly, packing of the products may be part of the manufacturing process described above. If the process includes a drying step described above, there are no special requirements for the packing, except that the packing step and the package must be suitable for edible products. If the process does not include the drying step, or if the process includes rehydrating the dried first product, the resulting product is preferably packed into an airtight enclosure, such as a vacuum pack, to prevent spoilage. Preferably, the process includes also a sterilization step at elevated temperature and pressure, e.g. in an autoclave. Conditions for the sterilization step are known to those skilled in the art.

Further processing of the extruded first and second products may also include seasoning of the products before being optionally packed. Seasoning can be carried out as explained above when discussing features of the product of the invention. Accordingly, in some embodiments, the extruded first product obtained by the process described above, with or without a drying step, is hydrated or mixed with an aqueous liquid, preferably water, containing one or more flavouring agents, and optionally some oil together with an emulsifying agent to obtain a second textured plant protein product. However, in some embodiments, the flavouring agent(s) need not be premixed with the aqueous liquid, preferably water, before mixing the aqueous liquid with the extrudate. Usually, the extrudate, with or without being subjected to a prior drying step, in an amount of 25-40 wt % is mixed with the aqueous liquid in an amount of 60-75 wt % calculated from the total weight of the mixture. More preferably, the seasoning step comprises mixing of the extrudate in an amount 30-35 wt % with the aqueous liquid in an amount of 65-70 wt %.

The moist and seasoned textured plant protein product (i.e. a second textured plant protein product) is particularly suitable for use as a minced meat substitute, especially as a substitute for cooked minced meat. It may be consumed as such as, or used in preparing dishes such as pasta Bolognese, macaroni casserole, savoury pies and sauces that mimic minced meat sauces, to name some examples. It may also be used as savoury toppings or fillings for various food products such as pizzas or tacos. The product may be seasoned as desired, for example to resemble plain meat, especially by using umami flavours, or to resemble minced meat seasoned with various spices and herbs. While the second textured plant protein product is in itself devoid of any animal-derived material, i.e. is fully plant-based, it may be used in food products that contain animal-derived components such as meat or eggs.

### NON-EXHAUSTIVE LIST OF NUMBERED EMBODIMENTS

1. A textured plant protein product comprising:
   a plant protein component in an amount of 40-75% by dry weight,
   a cereal fibre component in an amount of 20-55% by dry weight, and
   syrup in an amount of 1-5% by dry weight.
2. The textured plant protein product according to embodiment 1 having a total protein content of 30-80% by dry weight, and/or a total dietary fibre content of 9-25% by dry weight, and/or a total beta-glucan content of 3-9% by dry weight.
3. The textured plant protein product according to embodiments 1 or 2, wherein the plant protein component comprises a legume protein component, preferably derived from a legume selected from the group consisting of peas, fava beans, chickpeas, lentils, peanuts, trefoil, pinto beans, haricot beans, mung beans, navy beans, red beans, black beans, dark and light red kidney beans, green baby lima beans, pink beans, myasi beans, black eyed beans, cranberry beans, white beans, rice beans, and butter beans.
4. The textured plant protein product according to embodiment 3, wherein the legume protein component consists of a single legume protein component, preferably a pea protein component; or comprises two different legume protein components, preferably a pea protein component and a fava bean protein component.
5. The textured plant protein product according to any one of embodiments 1-4, wherein the cereal fibre component is a cereal bran component, preferably an oat bran component, more preferably an oat bran concentrate.
6. The textured plant protein product according to any one of embodiments 1-5, wherein the syrup comprises or consists of a component selected from molasses such as cane molasses, sugar beet molasses and fruit molasses, and malt extracts such as barley malt extracts and oat malt extracts.
7. The textured plant protein product according to any one of embodiments 1-5, wherein the syrup is molasses such as cane molasses, sugar beet molasses or fruit molasses; or malt extract such as barley malt extract or oat malt extract.
8. The textured plant protein product according to any one of embodiments 1-7, wherein the product has a moisture content of 6-12% by weight.
9. The textured plant protein product according to any one of embodiments 1-7, wherein the product has a moisture content of 68-87%, preferably 60-75% by weight.
10. The textured plant protein product according to any one of embodiments 1-9, further comprising one or more flavouring agents in a total amount of up to 10% by dry weight.
11. The textured plant protein product according to any one of claim 1-7, 9 or 10 wherein the textured plant protein product is a minced meat substitute, a minced meat extender, a pizza topping or filling, or a taco topping or filling.
12. A method of preparing a textured plant protein product by a low-moisture protein texturization extrusion, the method comprising:
   providing ingredients comprising a plant protein component in an amount of 40-75% by dry weight, a cereal fibre component in an amount of 20-55% by dry weight, and syrup in an amount of 1-5% by dry weight, all amounts being based on the total dry weight of the ingredients, into an extruder;
   mixing the ingredients with water to provide a hydrated ingredient mixture, the amount of water being up to 40% by weight of the total weight of the hydrated ingredient mixture;
   kneading the hydrated ingredient mixture at a temperature lower than 170 °C in the extruder to form a dough composition;
   passing the dough composition through a die assembly to form a textured plant protein product with substantially aligned protein fibres.
13. The method according to embodiment 12, wherein the plant protein component and the cereal fibre component are fed into a preconditioner, optionally in a premixture.
14. The method according to embodiment 13, wherein the plant protein component and the cereal fibre component are mixed with water in the preconditioner.
15. The method according to any one of embodiments 12-14, wherein the syrup, optionally with additional water, is fed into a first barrel of the extruder.
16. The method according to any one of embodiments 12-15, wherein the textured plant protein product with substantially aligned protein fibres is cut to have an average particle size of 1-15 mm.
17. The method according to according to any one of embodiment 12-16, further comprising drying the textured plant protein product with substantially aligned protein fibres to a moisture content of less than 12% by weight of the total weight of the product.
18. The method according to any one of embodiments 12-17, further comprising mixing of the textured plant protein product with substantially aligned protein fibres with an aqueous liquid to provide a moisture content of 60-87%, more preferably 60-75% by weight of the product.
19. The method according embodiment 17 or 18, wherein the textured plant protein product with substantially aligned protein fibres is seasoned with one or more flavouring agents, preferably in a total amount of up to 10% by dry weight.
20. The method according to embodiment 18 or 19, wherein the textured plant protein product is a food product resembling cooked minced meat.
21. The method according to any one of embodiments 12-20, further comprising packing, preferably vacuum packing of the texture plant protein product with substantially aligned protein fibres.
22. The method according to any one of embodiments 12-21, wherein the textured plant protein product with substantially aligned protein fibres has a feature set forth in any one of embodiments 1-11.
23. A textured plant protein product obtainable by the method according to any one of embodiments 12-22.
24. A food product comprising the textured fava bean protein product according to any one of embodiments 1-11 or 23.
25. The food product according to embodiment 24, wherein the food product is a a meat ball, a meat ball imitation, a burger, a burger imitation, sausage, a sausage imitation, a meat loaf, a meat loaf imitation, a casserole, a savoury pie, a taco, a pizza, a savoury sauce, a ready-made meal.

### EXAMPLES

### Example 1. Preparation and Evaluation of Textured Plant Protein Products

Different recipes were tested with an aim to prepare a versatile textured plant protein product with high protein and dietary fibre content, as well as with good organoleptic properties. Some test recipes are shown in Table 1 below, wherein all amounts are given as wt % on dry basis.

All test products were manufactured using a Bühler twin-screw 7-barrel extrusion system equipped with a preconditioner and a cutting head, followed by a fluid belt dryer.

Dry ingredients were fed into the preconditioner and mixed with water. The hydrated mixture was then passed into the first barrel. More water was fed into the first barrel. Also molasses was fed into the first barrel. The temperature profile was adjusted such that the temperature was the highest, around 165 °C, in the last barrel. The cutting speed was set such that the particle size varied between 3 and 7 mm. After cutting, the extruded products were dried to a moisture content below 10 wt %.

TABLE 1
Exemplary recipes

| | | Fava | | | | | | |
|---|---|---|---|---|---|---|---|---|
| | Pea | bean | Oat | | | | | |
| Recipe | protein | protein | bran | Oat | | Dietary | Beta- | |
| # | comp. | comp. | conc. | flour | Molasses | fibres | glucan | Protein |
| 1 | 35 | 6 | 9 | 46 | 4 | 8.7 | 2.3 | 41.3 |
| 2 | 34 | 26 | 36 | | 4 | 14.6 | 5.4 | 51.7 |
| 3 | 34 | 16 | 46 | | 4 | 16.6 | 6.9 | 47.8 |

Recipe 1 (comparative): The extrusion process was unstable and not suitable for industrial production. However, the extrudate had a rather good and fibrous texture, although it was somewhat rough.
Recipe 2: The extrusion process and the product flow were stable. The extrudate was rather dry but the fibrous texture was good.
Recipe 3: The extrusion process was stable. The extrudate was somewhat dry. After drying the extrudate was slightly harder than the extrudate of the other recipes.

Further recipes were tested in a different set of test runs. These recipes are shown in Table 2 below, wherein all amounts are given as wt % on dry basis.

Test products according to Recipes 4-7 were prepared in the same way as the test products according to Recipes 1-3.

TABLE 2
Further exemplary recipes

| | | Fava | | | | |
|---|---|---|---|---|---|---|
| | Pea | bean | Oat | | | |
| Recipe | protein | protein | bran | | Dietary | Beta- |
| # | component | component | concentrate | Molasses | fibres | glucan |
| 4 | 34.6 | 26.4 | 36.5 | 2.5 | 14.8 | 5.5 |
| 5 | 35.5 | 27.1 | 37.4 | — | 15.2 | 5.6 |
| 6 | 34.6 | 16.3 | 46.6 | 2.5 | 16.9 | 7.0 |
| 7 | 35.5 | 16.7 | 47.8 | — | 17.3 | 7.2 |

It was unexpectedly found that including molasses in the recipes caused the extruded ribbon to be wider and to have a more round and uniform cross-sectional area along the longitudinal axis of the ribbon. In the absence of molasses, the extruded ribbons were thinner and less uniform than in the presence of molasses.

### Example 2. Water Absorption Tests and Sensory Evaluations

These experiments were carried out in order to evaluate sensory properties of the products of Recipes 1-7 after soaking in water.

To this end, 100 g of water (37 °C) was added on top of 20 g of each of the textured protein products according to Recipes 1-3 in a beaker and mixed with gentle stirring using a spoon. After soaking for 5 min at room temperature, the products were subjected to sensory evaluation (Table 3).

These and other results indicated that dietary fibre content above 9% by dry weight was needed to achieved a good firm fibrous texture that does not dissolve in water and loose its texture.

Also products of Recipes 4-7 were hydrated and subjected to sensory evaluation. To this end, 100 g of water (37 °C) was added on top of 10 g of each of the textured protein products according to Recipes 4-7 in a beaker and mixed with gentle stirring using a spoon. After soaking for 5 min at room temperature, hydrated protein products were separated from non-absorbed water with a sieve, and both fractions were weighed. No compression was applied to the hydrated products in the sieve.

TABLE 3
Sensory evaluation of Recipes 1-3

| | | Firmness after 5 |
|---|---|---|
| | | min hydration (1 = |
| Recipe | Taste and other comments | soft, 5 = firm) |
| 1 | Strong taste of oats, texture disintegrated | 1 |
| | in water, too weak bite resistance | |
| 2 | Mild and neutral taste, texture present | 4 |
| | even after soaking in water for 30 min, | |
| | good bite resistance | |
| 3 | Mild and neutral taste, good bite resistance | 3 |

The weight sum of the hydrated products and non-absorbed water was not exactly 110 g, indicating that a minor amount of water was retained in the sieves. However, this was not considered to compromise the accuracy of the test results. The results along with a sensory evaluation are shown in Table 4 below.

TABLE 4
Results of water absorption test and sensory evaluation

| | | Non- | | Firmness after 5 min |
|---|---|---|---|---|
| | Bulk density | absorbed | Hydrated | hydration (1 = soft, |
| Recipe | (after dryer) | water (g) | product (g) | 5 = firm) |
| 4 | 167 | 50 | 54 | 3.5 |
| 5 | 188 | 49 | 58 | 2 |
| 6 | 191 | 68 | 39 | 4 |
| 7 | 173 | 44 | 59 | 2 |

Products of Recipes 4-7 were hydrated also in a lower amount of water (33 wt % of the extrudate and 67 wt % of water) for 5 min and evaluated for firmness and bite resistance. The results are shown in Table 5 below.

TABLE 5
Results of sensory evaluation after
hydration in a lower amount of water.

| | | Firmness after 5 min |
|---|---|---|
| Recipe | Sensory evaluation | hydration (1 = soft, 5 = firm) |
| 4 | Light brown colour; particle | 4 |
| | shape round; neutral taste; | |
| | texture firm and fibrous with | |
| | good bite resistance | |
| 5 | Light beige colour; particle | 2.5 |
| | shape thin; neutral taste, but | |
| | bitter aftertaste; poor fibrous | |
| | texture and bite resistance | |
| 6 | Light brown colour; particle | 4.5 |
| | shape round; neutral taste, | |
| | only slight bitter aftertaste; | |
| | fibrous texture, very good bite | |
| | resistance | |
| 7 | Light beige colour; particle | 2 |
| | shape thin; neutral taste, but | |
| | bitter aftertaste; very poor | |
| | fibrous texture and bite | |
| | resistance | |

Products containing molasses were clearly different from the product without molasses in their firmness after soaking in water. Products without molasses were very soft after soaking making their use in various food applications practically impossible. For example, when used as a meat replacement in vegetarian or vegan food products, such as meat ball, burger, sausage or meat loaf imitations, it is important that the textured protein product not only provides protein into the product, but also gives sufficient bite resistance and meat-like texture to the food product. If the firmness and structural integrity of the textured protein product is lost after rehydration, no proper meat imitation properties are achieved. This problem was overcome by including molasses in the products.

Moreover, the taste was too bitter in the absence of molasses. Also this problem was overcome using molasses in the products.

### Example 3. Preparation of Plant-Based Meat Alternative Resembling Pan Fried Minced Meat

Dry extrudates according to Recipes 4 and 6 were rehydrated for 5 min and seasoned by mixing 33 wt % of dry extrudates with 67 wt % of water containing 5 various spices and herbs in a total amount of 5 wt %. The mixture was fried on a frying pan and served as a substitute for minced meat.

A group of 16 expert panelists rated the product for organoleptic properties in comparison to minced meat. Using a scale from 1 to 5 (1=poor; 5=excellent). the product received an average rating of 3.8, which result was considered to indicate that the target was achieved and the product resembled minced meet very well.

Free verbal comments included the following:

“Meaty” taste, which is a good feature from meat-eaters' perspective; excellent texture. Pleasant texture, plain product just like normal minced meat. Excellent taste; meaty texture, somewhat hardy. Appealing texture. Is this chicken?

1. A textured plant protein product comprising syrup in an amount of 1-5% by dry weight and a cereal component, the product having a total plant protein content of 30-80% by dry weight, and a total dietary fibre content of 9-25% by dry weight.

2. The textured plant protein product according to claim 1, wherein the syrup comprises a component selected from the group consisting of molasses, such as cane molasses, sugar beet molasses and fruit molasses; corn syrup; brown rice syrup; glucose syrup; inverted sugar syrup; palm syrup; malt extract such as barley malt extract and oat malt extract.

3. The textured plant protein product according to claim 1, wherein the cereal component is a cereal fibre component.

4. The textured plant protein product according to claim 3, wherein the cereal fibre component is present in an amount of 20-55% by dry weight.

5. The textured plant protein product according to claim 1 having a total beta-glucan content of 3-9% by dry weight.

6. Textured plant protein product according to claim 1, wherein the product comprises a plant protein component.

7. The textured plant protein product according to claim 1, wherein the plant protein comprises a legume protein component.

8. The textured plant protein product according to claim 7, wherein the legume protein component consists of a single legume protein component.

9. The textured plant protein product according to claim 1, wherein the product has a moisture content of 6-12% by weight.

10. The textured plant protein product according to claim 1, wherein the product has a moisture content of 60-87%.

11. The textured plant protein product according to claim 1, further comprising one or more flavouring agents in a total amount of up to 10% by dry weight.

12. The textured plant protein product according to claim 1, wherein the textured plant protein product is a minced meat substitute.

13. The textured plant protein product according to claim 1, wherein the syrup is present during protein texturization.

14. The textured plant protein product according to claim 1, wherein the product is a meat substitute, a meat extender, a pizza topping or filling, or a taco topping or filling.

15. A method of preparing the textured plant protein product according to claim 1 by a protein texturization extrusion, the method comprising:
providing ingredients comprising syrup in an amount of 1-5% by dry weight of the total dry weight of the ingredients, a plant protein component and a cereal component into an extruder;
mixing the ingredients with water to provide a hydrated ingredient mixture, the amount of water being up to 40% by weight of the total weight of the hydrated ingredient mixture;
kneading the hydrated ingredient mixture at a temperature lower than 170 °C in the extruder to form a dough composition;
passing the dough composition through a die assembly to form a textured first plant protein product with substantially aligned protein fibres.

16. The method according to claim 15, wherein the ingredients comprise a plant protein component in an amount of 40-75% by dry weight and a cereal fibre component in an amount of 20-55% by dry weight, both based on the total dry weight of the ingredients.

17. The method according to claim 15, wherein the textured first plant protein product is cut to have an average particle size of 1-15 mm.

18. The method according to claim 15, further comprising drying the textured first plant protein product to a moisture content of less than 12% by weight.

19. The method according to claim 15, further comprising mixing of the textured first plant protein product with one or more optional flavouring agents and an aqueous liquid to provide a textured second plant protein product.

20. The method according to claim 19, wherein the textured second plant protein product is a food product resembling cooked minced meat.

21. The method according to claim 15, further comprising packing of the textured first or second plant protein product.

22. The method according to claim 15, wherein the textured plant protein product with substantially aligned protein fibres has a feature set forth in claim 1.

23. The method according to claim 15, wherein the protein texturization extrusion is low-moisture protein texturization extrusion.

24. A textured plant protein product according to claim 1 obtainable by the method according to claim 15.

25. A food product comprising the textured fava bean protein product according to claim 24.

26. The food product according to claim 25, wherein the food product is a meat ball, a meat ball imitation, a burger, a burger imitation, a sausage, a sausage imitation, a meat loaf, a meat loaf imitation, a casserole, a savoury pie, a taco, a pizza, a savoury sauce, a ready-made meal.
